(19) United States
(12) Patent Application Publication
(10) Pub. No.: US 2014/0129442 A1
(43) Pub. Date: May 8, 2014

(54) FINANCIAL INSTITUTION ACCOUNT NETWORKING

(71) Applicant: BANK OF AMERICA CORPORATION, Charlotte, NC (US)

(72) Inventors: Carrie Anne Hanson, Charlotte, NC (US); Leland E. Modesitt, Charlotte, NC (US); Katherine Dintenfass, Charlotte, NC (US); Alexander C. Wittkowski, Charlotte, NC (US); Laura Corinne Bondesen, Charlotte, NC (US); Marc Lance Warshawsky, Charlotte, NC (US); Jon R. Wolf, Charlotte, NC (US); Scott R. Enscoe, Charlotte, NC (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(73) Assignee: BANK OF AMERICA CORPORATION, Charlotte, NC (US)

(21) Appl. No.: 13/667,753

(22) Filed: Nov. 2, 2012

(51) Int. Cl. G06Q 20/38; G06Q 20/40

(52) U.S. Cl. 705/44; 705/39

(57) ABSTRACT

Embodiments of the invention include systems, methods, and computer-program products for provide a user with a central location that links one or more of the user's financial accounts into a single location for viewing and transacting with any of the one or more financial accounts. As such, the invention provides a facilitated access to one or more user financial accounts from any or all financial institutions consolidated into one source. Embodiments of the present invention provide a system for financial account linkage. Specifically, embodiments of the invention allow for monitoring, viewing, transacting, and transferring funds associated with any of the financial accounts of a user. The financial account monitoring program may be provided to a user via his/her mobile device in an interactive account monitoring/transaction fashion.

### BACKGROUND

Typically, individuals have several financial institution accounts, including, but not limited to, savings accounts, checking accounts, credit card accounts, and the like. While some of these accounts may be with the same financial institution, many times individuals have one account with one financial institution and another account with a different financial institution.

More often, individuals wish to transfer funds from one account to another account. For example, an individual may wish to transfer funds from a savings account into his/her checking account to make a large purchase. Because of recent online and mobile banking technologies, this transfer is usually easy for the individual to accomplish. This is especially true when the two accounts associated with the transfer are managed by the same financial institution. However, if the accounts are associated with multiple financial institutions, the transfer typically requires more individual interaction. Many times these transactions require an individual accessing both financial institutions' on-line or mobile banking applications to complete a transfer and/or physically conducting the transaction in a branch.

### BRIEF SUMMARY

Embodiments of the present invention address the above needs and/or achieve other advantages by providing apparatuses (e.g., a system, computer program product and/or other devices) and methods for creating and managing a user financial institution account network, that allows a user to easily visualize, transact, and link multiple financial institution accounts (from multiple financial institutions) at a single location. As such, the invention provides a facilitated access and transaction capabilities to all user financial institution accounts consolidated into one reliable source.

Embodiments of the present invention provide a system for linking user financial accounts into one accessible location. As such, providing the user with a central node through which he/she can manage his/her entire financial ecosystem. Specifically, embodiments of the invention allow for enrolling in a mobile banking application managed by a first financial institution, determining user financial accounts associated with the first financial institution, determining user financial accounts associated with one or more other financial institutions, linking the financial accounts from the various financial institutions, allowing a user to view, access, review, transaction, and the like all user financial accounts from one location.

In some embodiments, the system may be associated with a financial institution managing a user's mobile banking application. As such, the system may allow the user to enroll in a mobile banking application via a user device. In this way, the user's financial accounts associated with the financial institution managing the user's mobile banking application may be viewable via that application. As such, the user may view account data, history, balances, and the like.

The system may then determine other financial accounts the user may have. These financial accounts may be with one or more other financial institutions that are not providing the user with the mobile banking application. The system may determine these financial accounts and communicate with the financial institutions that are managing the accounts. In this way, the system may obtain information associated with the financial accounts, such as account numbers, balances, and the like.

The system may then link the financial accounts from the various financial institutions onto one accessible location to provide the user with a financial account network. In some embodiments, the system may provide the accessible location via an application displayable on a user device.

The system allows a user to view, access, review, transaction, transfer funds, and the like between the linked financial accounts. For example, if a user would like to transfer funds from a checking account he/she has with Bank 1 to a savings account he/she has with Bank 2, the user may access the application and direct funds from the checking account to the savings account. In this way, by accessing a single application a user may be able to manipulate funds across several different accounts managed by one or more financial institutions. Furthermore, the user may be able to manage all of the accounts from the application. In some embodiments, the application may be interactive, such that the user may be able to swipe, move, icon, scroll, or the like between the accounts and/or financial institutions associated therewith in order to manage each of the various financial accounts linked by the system.

Furthermore, the system allows a user to use any one of the linked financial accounts to transaction with an outside vendor if necessary. As such, the system may link to one or more of the user's financial accounts to allow a user to transact using the account.

Embodiments of the invention relate to systems, methods, and computer program products for a link between one or more financial accounts, the invention comprising: receive an indication that a user accesses a first one or more financial accounts electronically, wherein accessing the first one or more financial accounts electronically includes accessing the first one or more financial accounts via online or mobile accessing capabilities, wherein the first one or more financial accounts are managed by a first financial institution; receive information of a second one or more financial accounts associated with the user, wherein the second one or more financial accounts are managed by one or more other financial institutions; determine, based on received information, an account type and the one or more other financial institutions managing the second one or more financial accounts; communicate with the first financial institution and the one or more other financial institutions; link the first one or more financial accounts with the second one or more financial accounts together into a single application; allow for transacting between the linked first one or more financial accounts and the second one or more financial accounts; and provide viewable indication of the transaction and effects of the transaction on the first one or more financial accounts and the second one or more financial accounts via the single application.

In some embodiments, determining an account type and the one or more other financial institutions managing the second one or more financial accounts comprises recognizing user input of financial accounts information associated with the second one or more financial accounts, wherein financial account information includes one or more of an account number, routing number, or account identification number. In other embodiments, determining an account type and the one or more other financial institutions managing the second one or more financial accounts comprises recognizing the second one or more financial accounts when a statement associated with the second one or more financial accounts is sent to the user, wherein the one or more other financial institutions sends the statement to the user electronically. In yet other embodiments, determining an account type and the one or more other financial institutions managing the second one or more financial accounts comprises recognizing a captured image of an article comprising financial accounts information associated with the second one or more financial accounts, wherein the captured image is captured via an image capture device, such as a camera, wherein financial account information includes one or more of an account number, routing number, or account identification number.

In some embodiments, communicating with the first financial institution and the one or more other financial institutions further comprises communicating with the first financial institution and the one or more other financial institutions to receive authorization to transact using the first one or more financial accounts and the second one or more financial accounts associated with the user.

In some embodiments, the invention is further configured to allow for tracking between the first one or more financial accounts and the second one or more financial accounts associated with the user, such that the tracking allows for transferring of funds across the first one or more financial accounts and the second one or more financial accounts.

In some embodiments, the invention is further configured to allow transacting with third party entities using the linked first one or more financial accounts and the second one or more financial accounts using a single application, wherein the transaction occurs independent of managing financial institution.

In some embodiments, providing viewable indication of the transaction and effects of the transaction on the first one or more financial accounts and the second one or more financial accounts via the single application further comprises displaying financial account information such as account balance associated with each of the first one or more financial accounts and the second one or more financial accounts on single viewable application.

In some embodiments, the invention is further configured to allow for visual overlaid circles including a managing financial institution in one circle and a one or more financial accounts from the managing financial institution overlaid in a second or more circles.

In some embodiments, the invention is further configured to notify the user of any changes in the linked first one or more financial accounts and the second one or more financial accounts, wherein changes include account balance changes or transactions occurring using the linked first one or more financial accounts or the second one or more financial accounts.

In some embodiments, the invention is further configured to monitor the linked first one or more financial accounts and the second one or more financial accounts statement history for the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a financial account networking program method for financial account management, in accordance with one embodiment of the present invention;

FIG. 2 provides a financial account networking system environment, in accordance with one embodiment of the present invention;

FIG. 3 provides a process flow illustrating methods of determining financial accounts associated with a user for linking, in accordance with one embodiment of the present invention;

FIG. 4 provides a process flow illustrating system process for linking financial accounts associated with a user, in accordance with one embodiment of the present invention;

FIG. 5 provides a process flow illustrating transaction and management functions available for financial accounts via the financial account networking program, in accordance with one embodiment of the present invention;

FIG. 6 provides a process flow illustrating user decision process for using the financial account network program, in accordance with one embodiment of the present invention; and

FIG. 7 provides user interfaces for the financial account network program, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. A “financial account” or “account” as used herein may refer to any checking, savings, money market, certified deposit, credit card, line of credit, debit account, and/or the like that a user may have with a financial institution or similar entity. Furthermore, a “vendor” as used herein may refer to any third party that a user may have transacted with for products, services, or the like. In this way, a vendor may be a merchant, service provider, contractor, business, individual or entity that may have transacted with the user.

Some portions of this disclosure are written in terms of a financial institution's unique position with respect to payment account and payment device providers. As such, a financial institution may be able to utilize its unique position to facilitate some of the functionality for the financial account networking program to operate.

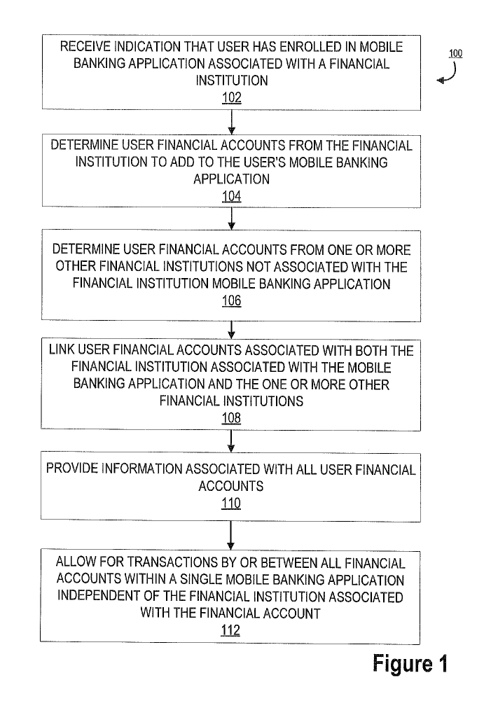

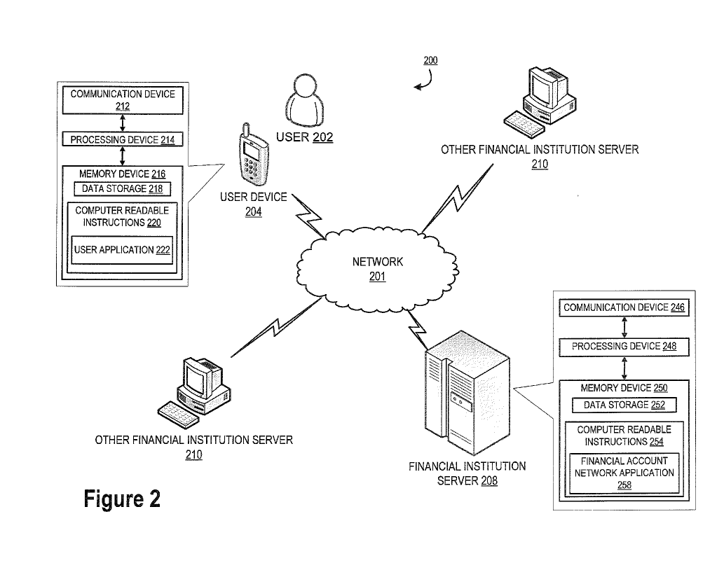

FIG. 1 provides a high level process flow illustrating a financial account networking program method for financial account management 100, which will be discussed in further detail throughout this specification with respect to FIG. 2 through FIG. 7. The first step in the process 100, as illustrated in block 102 is receiving an indication that the user has enrolled in a mobile banking application associated with a financial institution. In some embodiments, the user may enroll in a mobile banking. In other embodiments, the user may have enrolled in online banking. In this way, the term mobile banking application, as used herein may refer to online banking, mobile banking, or other electronic applications such as tablet or the like.

Next, as illustrated in block 104, the system may determine user financial accounts from the financial institution to add to the user's application. In this way, the user may have one or more accounts, such as a checking account, savings account, credit card, debit account, or the like with the financial institution. Once those accounts are determined, they may be added to the application.

As illustrated in block 106, after the user has enrolled and has his/her accounts from the financial institution on a mobile banking application, the system may determine user financial accounts from one or more other financial institutions not associated with the application. In this way, if the user has a mobile banking application with Bank 1, the system may also determine accounts the user has with Bank 2, Bank 3, Bank 4, and the like.

Next, as illustrated in block 108, the system may link the user financial accounts associated with both the financial institution associated with the mobile banking application and the one or more other financial institutions. In this way, all of the user financial accounts, irrespective of what financial institution the financial account is managed by, may be linked together.

Next, because all financial accounts of a user are linked, the system may provide information associated with all of the user's linked financial accounts, as illustrated in block 110. In this way, the user may be able to view, in one location, all information associated with each of the user's financial accounts. The information includes, but is not limited to, account numbers, account balances, account history, and the like.

Finally, as illustrated in block 112, the system allows for transactions by or between the financial accounts within a single application, independent of the financial institution associated with the financial account. In some embodiments, the system may allow for transactions via an interactive interface which may include sliding, texting, voice activation, swiping, and the like. For example, a user may be able to transfer funds between a checking account managed by Bank 1 and a savings account managed by Bank 2. In this way, the financial account networking system allows for viewing and transferring funds between financial accounts via a single location.

FIG. 2 provides a financial account networking system environment 200, in accordance with one embodiment of the present invention. As illustrated in FIG. 2, the financial institution server 208 is operatively coupled, via a network 201 to the user device 204 and the other financial institution servers 210. In this way, the financial institution server 208 can send information to and receive information from the user device 204 and the other financial institution servers 210 to provide a user with a central node that links one or more of the user's financial accounts into a single location for viewing, monitoring, transacting, and transferring using any of the one or more financial accounts.

FIG. 2 illustrates only one example of an embodiment of financial account networking system 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual that may have one or more financial accounts with one or more financial institutions. As such, in some embodiments, the user 202 may have made one or more transaction accounts, such as a savings account, checking account, certificate of deposit, stock, or the like. The user 202 may also have one or more of a credit card account, debit card account, or the like with a financial institution. Furthermore, in some embodiments, the user 202 may be an entity or a person, employee, agent, independent contractor, or the like acting on behalf of the entity to us an entity associated financial account.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the other financial institution server 210 and the user device 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial account network application 258. In some embodiments, the memory device 250 includes database storage 252 for storing data related to the financial account network application 258 including but not limited to data created and/or used by the financial account network application 258.

In the embodiments illustrated in FIG. 2 and described throughout much of this specification, the financial account network application 258 allows for providing system for linking one or more of the user's financial accounts into a single location for viewing, monitoring, transacting, and transferring using any of the user's financial accounts, irrespective of the financial institution that manages the account. As such, the financial account network application 258 may determine user financial accounts, link user financial accounts, provide information associated with the user financial accounts, allow for transactions between financial accounts via a single location, and allowing for transactions using any of the financial accounts via a single location.

The financial account network application 258 may determine user financial accounts. In some embodiments, the user financial accounts may be from the financial institution providing the financial account networking program. In some embodiments, the financial institution accounts may be from one or more other financial institutions providing financial accounts. In some embodiments, the financial account network application 258 may determine user financial accounts automatically. In other embodiments, the financial account network application 258 may determine user financial accounts based on user input of information associated with the financial account, such as financial institution associated with the account, account number, routing number, and/or the like.

In some embodiments, the user financial accounts may be from the financial institution providing the financial account networking program. As such, the user 202 may bank with the financial institution associated with the financial institution server 208. In this way, the financial account network application 258 may already have access to the financial account information for the user financial account associated with the financial institution associated with the financial institution server 208. In some embodiments, the user financial accounts may be from one or more other financial institutions, wherein the other financial institutions are not providing the financial account networking program. In this way, the system may, in some embodiments, receive financial account information from other financial institutions automatically, via other financial institution servers 210 via a network 201. In this way, the financial account network application 258 may communicate using the communication device 246 with other systems on the network 201, such as the other financial institution servers 210 to access user financial accounts associated with the user 202. In other embodiments, the user 202 may manually input, via his/her user device 204, the financial account information. In this way, the financial account network application 258 may receive financial accounts directly from other financial institutions, from the user 202, or from the financial institution providing the financial account networking program.

Once the user's financial accounts are determined, the financial account network application 258 may be able to track and communicate with the financial institution providing the financial account. In this way, the financial account network application 258 may be able to access the information associated with the financial account and be able to provide the user 202 with real-time information associated with the financial account.

Next, the financial account network application 258 may link user financial accounts. In this way, the financial account network application 258 may link financial accounts associated with the financial institution providing the financial account networking program and/or financial accounts associated with other financial institutions. This linkage allows the financial account network application 258 to link all user 202 financial accounts into one location, such that a user 202 may be able to visualize information associated with each of his/her financial accounts at one time via his/her user device 204. The linking further allows the user 202 to transfer funds across accounts using the linkage.

The financial account network application 258, once linking the financial accounts, the financial account network application 258 may be able to provide information associated with each of the user financial accounts. Because of the linkage, the financial account network application 258 through the communication device 246 may communicate via a network 201 to the other financial institution servers 210 in order to receive, in real-time, information associated with the user financial accounts. The information includes, but is not limited to, account history, account balance, and/or the like. In this way, the system may be able to provide the user 202 with a visual representation of the user's accounts in one holistic view for easy monitoring and account manipulation.

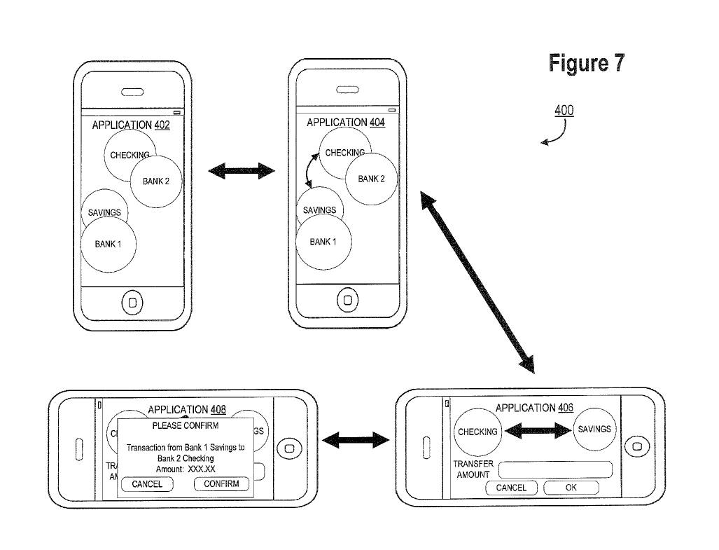

Next, the financial account network application 258 may allow for transactions between the financial accounts on the financial account networking system and/or allow for transactions using the financial accounts. In some embodiments, the financial account network application 258 may allow for transactions between the financial accounts. In this way, the financial account network application 258 may link the user's financial accounts and using this linkage allow for transactions between the financial accounts. In this way, the financial account network application 258 may allow a user to track a linkage to send/receive funds at various one or more financial accounts. For example, a user 202 may wish to move funds from a checking account at Bank 1 to a savings account at Bank 2. As such, the user 202 may track the linkage between Bank 1 and Bank 2 created by the financial account networking program to make the transfer. In this way, the user 202 may use an interface on his/her user device 204 to track or selection the different accounts to transact between. Importantly, the accounts may be displayed to the user 202 on one screen, such that the user 202 may be able to transaction between some or all of his/her financial accounts using a single screen associated with the interface, as further illustrated in the interfaces of FIG. 7.

Furthermore, the financial account network application 258, in other embodiments, may allow for the user 202 to transact using any of the financial accounts with another entity. In this way, because of the linkage, the financial account network application 258 is able to link a user 202 via the interface, to any one of the financial accounts associated with the user 202. In this way, a user 202 may be able to select a financial account using the financial account networking program and be able to use that financial account to transact with an outside entity. For example, a user 202 may wish to use his/her credit card account from Bank 3 to provide payment for a bill. The user 202 may select the credit card account using his/her financial account networking program and direct a payment to the entity associated with the bill.

Finally, the financial account network application 258 may allow a user 202 to confirm a transaction between or with user financial accounts on the financial account network. In this way, the financial account network application 258 may allow a user 202 to select and make a transaction using an interface associated with the financial account network program, and subsequently confirm the transaction via his/her user device 204. As such, the financial account network application 258 may communicate the transaction to the financial institution server managing the financial account, via either other financial institution servers 210 or the financial institution server 208 over the network 201. The user 202 may be provided the confirmation by the financial account network application 258 using the communication device 246 through the network 201 to the user device 204.

FIG. 2 also illustrates a user device 204. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the other financial institution server 210 and the financial institution server 208. As such, the communication device 212 generally comprises a modem, server, or other device for communicating with other devices on the network 201.

As further illustrated in FIG. 2, the user device 204 comprises computer-readable instructions 220 stored in the memory device 216, which in one embodiment includes a data storage 218 and the computer-readable instructions 220 of a user application 222. In this way, the user application 222 allows a user 202 to have and/or support a mobile wallet and/or mobile banking application or interface (or online banking application or interface). A “user device” 204 may be any mobile communication device, such as a cellular telecommunications device (e.g., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 204 is depicted in FIG. 2, the system environment 200 may contain numerous user devices 204.

In some embodiments, the user application 222 allows a user 202 to utilize his/her user device 204 as a financial account networking interface to access, provide input, receive information associated with financial accounts, and conduct transactions by/between the user's financial accounts.

The user application 222 may allow a user 202 to utilize his/her user device 204 to access user financial accounts from one or more financial institutions. As such, the user application 222 may communicate using the network 201 with the financial institution server 208 to access the user's financial account networking program. In this way, the user application 222 may authorize the user device 204 as being associated with the user 202 such that the user device 204 may be able to securely access the user's financial account networking program.

The user application 222 may also allow a user 202 to add information to his/her user financial account networking program. In this way, the user 202 may be able to input financial accounts, financial institutions associated with financial accounts, and/or the like. The user 202 may be able to input this data via text, voice, image recognition, or the like. The user device 204 may communicate the information associated with the added data via the communication device 212 through a network 201 to the financial institution server 208.

The user application 222 may also receive information associated with financial accounts via the financial account networking program. In this way, the user 202 may be able to monitor all of his/her financial accounts, balances, transfers, history, and the like associated with the user financial accounts on the user's financial account networking program.

Finally, the user application 222 allows the user 202 to utilize the user device 204 to conduct transactions by/between the user's financial accounts. In this way, the user 202 may use his/her user device 204 to transfer funds between financial accounts and transact with other entities utilizing the same interface associated with the financial account networking program.

FIG. 2 also illustrates two other financial institution servers 210. The other financial institution server 210 is operatively coupled to the financial institution server 208 and the user device 204 through the network 201. The other financial institution servers 210 have systems with devices the same or similar to the devices described for the financial institution server 208 and/or user device 204 (e.g., communication device, processing device, and memory device). Therefore, the other financial institution servers 210 may communicate with the financial institution server 208 and/or user device 204 in the same or similar way as previously described with respect to each system. The other financial institution servers 210, in some embodiments, are comprised of systems and devices that allow for sending and receiving information associated with user financial accounts. In this way, the other financial institution servers 210 may send information associated with the user financial accounts directly to the financial institution server 208 for creating a linkage by adding the financial account to the user financial account networking program.

Furthermore, the other financial institution server 210 communicate with the financial institution server 208 to send real-time updates regarding financial accounts, such that the system may provide these updates to the user 202 via his/her financial account networking program.

It is understood that the servers, systems, and devices described herein illustrate one embodiment of the invention. It is further understood that one or more of the servers, systems, and devices can be combined in other embodiments and still function in the same or similar way as the embodiments described herein.

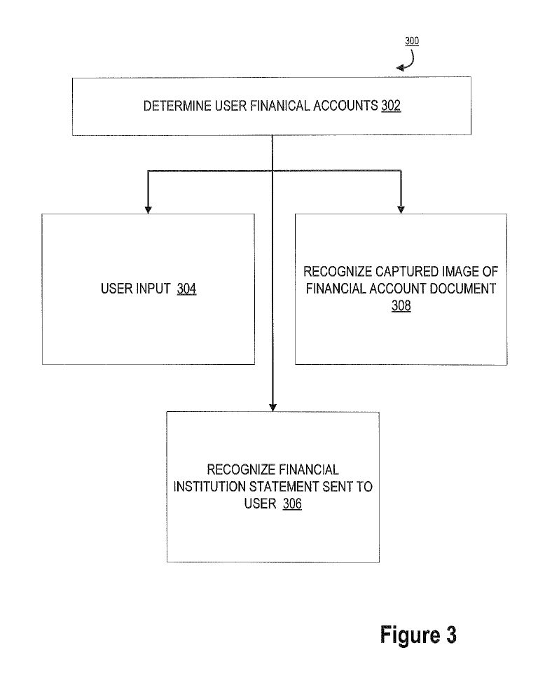

FIG. 3 illustrates a process flow of determining financial accounts associated with a user for linking 300, in accordance with one embodiment of the present invention. As illustrated in block 302, the system may have to determine user financial accounts such that the user financial accounts may be compiled for the user's financial account networking program. In some embodiments, the user financial accounts may be determined automatically. In other embodiments, the user may provide information associated with the user financial accounts to the system. The system may receive the user financial accounts directly from the financial institution, from a user 202, or the like.

There are three main ways of determining financial accounts 302 for a user 202 financial account networking program. As illustrated in block 304, one way of receiving user financial accounts for the user's financial account networking program is to receive user input, such as account number, routing number, financial institution associated therewith, and/or the like. In this way, the system may receive user 202 inputted data from a user device 204 or the like in order to populate financial accounts on the user financial account networking program. The user 202 inputted financial accounts may be from any of one or more financial institutions.

As illustrated in block 306, one way to determine financial accounts for the financial account networking program is to recognize financial institution statements sent to a user 202. In some embodiments, the statements may be recognized because they are sent electronically to the user device 204 over a network 201 in which the system may monitor and recognize the statements. This electronic sending may be via email, text message, or other electronic means of transmitting the statement. In other embodiments, the user 202 may request the financial institution send the statements directly to the system. In this way, the system may recognize the statement as being associated with the user 202 and link the financial account associated with the statement to the user's financial account networking program. For example, the system may recognize a financial statement sent to a user 202 via email. Once identified, the system may determine the statement originating financial institution, the financial account number, and the like, and automatically retrieve the financial account from the user's email and add it to the user's financial account networking program.

As illustrated in block 308 another way to determine financial accounts associated with a user 202 is by recognizing captured images of information associated with a financial account. This information may include a statement, check, deposit slip, receipt, credit card, debit card, and/or any other image that may comprise information associated with a financial account, such as an account number or the like. The captured images may be captured by a user 202 using an image capture device, such as a camera, user device 204, or the like. In other embodiments, the user 202 may be using a text capture device, such as a scanner or facsimile. Once the system receives a captured image or text associated with a financial account, the system may recognize the financial institution, the financial account number, and the like. The system may then add the determined information to the user's financial account networking program.

In all of the ways to determine financial accounts for a user 202 illustrated in FIG. 3, the system may follow up with the financial institution of the received financial account. In this way, the system may be able to directly communicate with the financial institution to create a link for the user's financial account networking program. As such, a user 202 may be able to visualize, manage, and transact using any of the determined financial accounts via the financial account networking program.

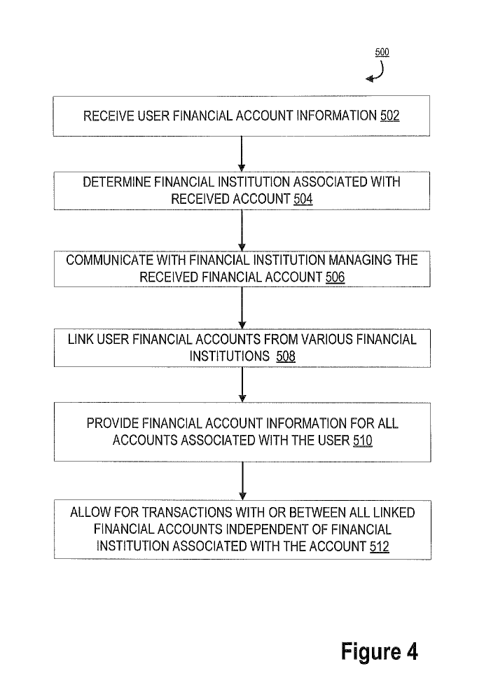

FIG. 4 illustrates provides a process flow illustrating system process for linking financial accounts associated with a user 500, in accordance with one embodiment of the present invention. As illustrated in block 502, the system may receive user financial account information. The financial account information, such as account number, financial institution associated with account, and/or the like. The financial account information may be received in any of the ways described above in FIG. 3 or the financial account information may be received directly from the financial institution providing the financial account networking program.

Next, as illustrated in block 504, the system may determine the financial institution associated with the financial account received. This includes determining the financial institution, financial institution contact information, and information associated with the financial account, such as, but not limited to, type of account, balance, transaction history, transaction reoccurrences, and the like.

After the system has determined the financial institution associated with a received financial account, the system may, as illustrated in block 506, communication with the financial institution managing/providing the received financial account. In some embodiments, this step of contacting the financial institution directly may need to be authorized by the user 202 prior to the system reaching out to the financial institution. In other embodiments, the system may contact the financial institution automatically to create a link for the financial account associated with the financial institution and/or receive real-time information associated with the financial account.

Next, as illustrated in block 508, the system may link the user financial accounts from various financial institutions into a financial account networking program. In this way, the system may allow for the linking of financial accounts from different financial institutions, such as Bank 1, Bank 2, Bank 3, and the like into one location, such that account information for all financial accounts may be viewable in that location. Furthermore, because of the linkage, the system allows a user to track the linkage to transact between financial accounts, such as transfer funds and/or the like.

Next, as illustrated in block 510, once the system has linked the financial accounts from the various financial institutions, the system may provide financial account information for all accounts associated with the user 202. In this way, because of the linkage, the system may provide the user 202 with information associated with all of his/her financial accounts via the financial account networking program. As such, a user 202 may be able to view each of his/her financial account in one location for easy balance review, transaction review, transacting, account manipulation, or the like.

Next, as illustrated in block 512 the system may allow for transactions with or between all linked financial accounts independent of the financial institution associated with the account. In this way, using the linkage, the system may allow a user 202 to track funds between each of the one or more financial accounts now linked on the user's financial account networking program.

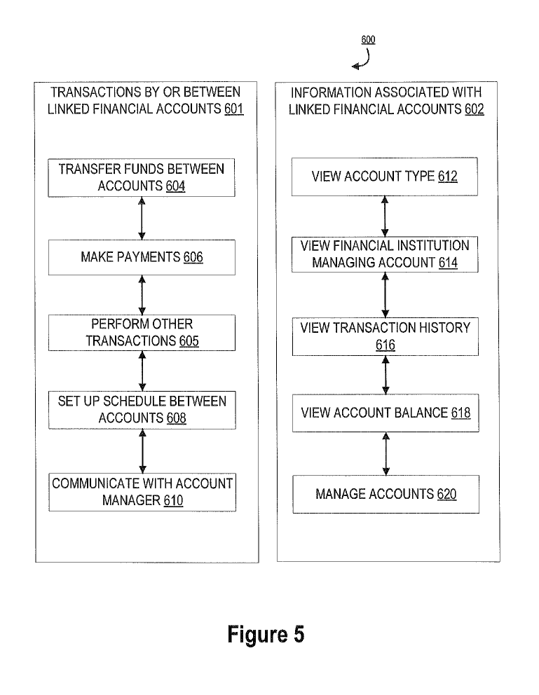

FIG. 5 illustrates a process flow for transaction and management functions available for financial accounts via the financial account networking program 600, in accordance with one embodiment of the present invention. FIG. 5 illustrates the transactions by or between linked financial accounts using the financial account networking program, as illustrated in block 601. FIG. 5 also illustrates the information associated with the linked financial accounts available via the financial account networking program, as illustrated in block 602.

As illustrated in section 601, the transactions by or between the linked financial accounts include, but are not limited to transferring funds between accounts within the financial account networking program, as illustrated in block 604. In block 606 the system allows for the user 202 to make payments via the accounts on the financial account networking program. In some embodiments, the system allows for payments from one account to another account on the financial account networking program. In other embodiments, the system allows a user 202 to make a payment using an account on the financial account networking program to tender payment to an entity not associated with the program. As illustrated in block 605, the system is set up such that it may be able to perform any other transaction such as those that are typically done via online or mobile banking. As illustrated in block 608, the system may also allow the user 202 to set up schedules between accounts. These schedules may include, but are not limited to, payment schedules, transfer schedules, or the like. As such, the user 202 may be able to set a time or date for a type of transaction to occur. The system may complete the transaction based on the set time or date without any further user 202 input. Finally, the system, as illustrated in block 610 may communicate with the financial institution managing the financial account. In this way, the system may receive real-time data from the financial institution associated with the financial accounts. As such, the user 202 may be able to view all user financial accounts associated with all financial institutions in a single location.

FIG. 5 further illustrates, in section 602, information that may be provided to the user 202 that is associated with the linked financial accounts on the financial account networking program. In some embodiments, the information may be displayed via an interface associated with the user device 204. In other embodiments, the information may be displayed to the user 202 via other electronic means. As illustrated in block 612, the system may provide a view of account types. In this way, the system may provide a user 202 a view of the types of financial accounts associated with the financial account networking program. These types may include savings accounts, checking accounts, certified deposits, credit card accounts, debit card accounts, and the like. This way, the user 202 may be able to visualize the checking account from Bank 1 and the checking account from Bank 2 easily, via the type, instead of account number or the like. As illustrated in block 614, the system may provide a visual representation of the financial institution that is managing or originating the financial account. As such, the system may provide the user 202 a representation of the accounts associated with Bank 1 and provide visualization of Bank 1 within the interface. In this way, if the user 202 has a checking account at Bank 1 and Bank 2, the user 202 may be able to distinguish the two based on bank of management. Next, as illustrated in block 616, the system may provide the user 202 with account transaction history. In this way, the user 202 may use the financial account networking program to review transaction history that the user 202 has made. Furthermore, the system may monitor the transaction history for any potentially different history and alert the user 202 of the history to prevent misuse of the user's account. As illustrated in block 618, the system may provide the user 202 with account balances for the financial accounts associated with the financial account networking program. As illustrated in block 620 the system also allows a user 202 to interactively manage all of his/her financial accounts associated with any financial institution.

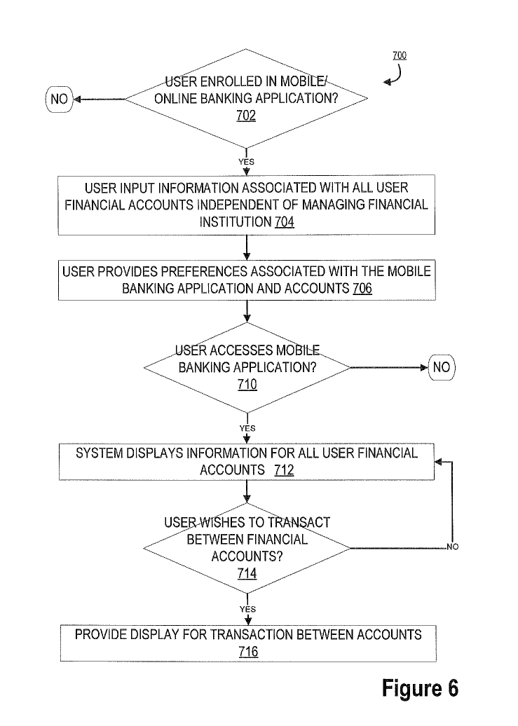

FIG. 6 illustrates a process flow of a user decision process for using the financial account network program 700, in accordance with one embodiment of the present invention. As illustrated in decision block 702 the user 202 may decide to enroll in a mobile or online banking application. If the user 202 does not decide to enroll in a mobile or online banking application, then the process 700 terminates. If the user 202 decides to enroll in a mobile or online banking application and takes the necessary steps of either enrolling or downloading, the process moves to block 704. At block 704 the user may input information associated with user financial accounts independent of what financial institution manages the account. As such, the system may be able to use this information to find or identify financial accounts associated with the user 202. In this way, the various ways of determining financial accounts associated with a user 202 are further described above with respect to FIG. 3.

Next, as illustrated in block 706 of FIG. 6, after the user or system has provided information associated with the financial accounts associated with the user 202 to the financial account networking program, the user 202 may provide preferences associated with the program and/or each of the various financial accounts associated thereon. In this way, the user 202 can individualize the user preferences for each of the one or more financial accounts on the financial account network program.

Once the user 202 has enrolled in a mobile or online banking application and provided information associated with his/her financial accounts, the system may communicate with the other financial institutions associated with the user's accounts. As such, the system may be able to provide real-time data associated with the financial accounts independent of what financial institution is providing the account. The user 202 may now, as illustrated in decision block 710, decide to access his/her mobile or online application. If the user 202 does not decide to access his/her application, then the process 700 terminates. If the user 202 does access his/her application then the system may display information associated with all of the user's financial accounts, including accounts from any financial institution, within the user's financial account networking program, as illustrated in block 712.

FIG. 7 illustrates user interfaces associated with the financial account network program 400, in accordance with one embodiment of the present invention. As illustrated in interface of an application 402, the system may display information associated with the user's financial accounts. In the interface illustrated in the application 402, this example user 202 has financial accounts with two banks, Bank 1 and Bank 2. The banks are represented by circles. The bank circles then are connected to any financial accounts associated that that bank. For example, in the example illustrated in the application 402 illustrated herein the user 202 has a checking account with Bank 2 and a savings account with Bank 1. In some embodiments, the overlying circles representing the financial account may also comprise one or more data associated with that particular financial account. This data may include an account balance, recent transactions, and/or the like. Furthermore, if the data that is displayed within the overlaid circle is not the data the user 202 is wishing to review, the user 202 may select the circle corresponding to the account and the system will access all information associated with that account.

Referring back to FIG. 6, at decision block 714, the user 202 may determine that he/she would like to transact between financial accounts on the financial account networking program. In this way, a user 202 may be able to make a payment, transfer funds, or the like interactively between financial accounts on the financial account networking system. If the user 202 does not wish to transact between financial accounts on the financial account networking system, the system may direct the user back to the display of account information. In some embodiments, the system may direct the user 202 to complete a transaction with an outside entity. If the user 202 does wish to transact between the financial accounts, the system may, as illustrated in block 716, provide a display for completing the transaction between the accounts.

FIG. 7 provides a visual representation of this transaction. As illustrated in the application interface 404 of FIG. 7 the user 202 may track the linkage between accounts on the user's financial account networking program. This tracking may be done via a slide, text, movement, or the like on the display. In the embodiment illustrated in the application interface 404 the user 202 may swipe between the circle representing his/her savings account at Bank 1 and his/her checking account at Bank 2 (as represented by the double sided arrow). As such, if the user 202 swipes between the savings and checking circles of application interface 404, the user may be directed to application interface 406. In application interface 406 the user 202 may, after swiping between circles be directed to input an amount to transfer between the checking and savings accounts. Once that amount has been inputted by the user 202, he/she may confirm the transfer amount by selecting the ok button. If the user 202 does not to make the transfer between the selected checking and savings accounts at this time, the user 202 may select the cancel button. If the use 202 selects the ok button, the user 202 is prompted to again confirm the transaction in interface application 408. In this example, the user 202 is asked by the system to confirm the transaction, a transfer of funds, from Bank 1 savings account to Bank 2 checking account in the amount of ______ dollars. Again, at this point the user 202 may confirm or cancel the transfer.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing a link between one or more financial accounts, the system comprising:
a memory device with computer-readable program code stored thereon;
a communication device;
a processing device operatively coupled to the memory device and the communication device, wherein the processing device is configured to execute the computer-readable program code to:
receive an indication that a user accesses a first one or more financial accounts electronically, wherein accessing the first one or more financial accounts electronically includes accessing the first one or more financial accounts via online or mobile accessing capabilities, wherein the first one or more financial accounts are managed by a first financial institution;
receive information of a second one or more financial accounts associated with the user, wherein the second one or more financial accounts are managed by one or more other financial institutions;
determine, based on received information, an account type and the one or more other financial institutions managing the second one or more financial accounts;
communicate with the first financial institution and the one or more other financial institutions;
link the first one or more financial accounts with the second one or more financial accounts together into a single application;
allow for transacting between the linked first one or more financial accounts and the second one or more financial accounts; and
provide viewable indication of the transaction and effects of the transaction on the first one or more financial accounts and the second one or more financial accounts via the single application.

2. The system of claim 1, wherein determining an account type and the one or more other financial institutions managing the second one or more financial accounts comprises recognizing user input of financial accounts information associated with the second one or more financial accounts, wherein financial account information includes one or more of an account number, routing number, or account identification number.

3. The system of claim 1, determining an account type and the one or more other financial institutions managing the second one or more financial accounts comprises recognizing the second one or more financial accounts when a statement associated with the second one or more financial accounts is sent to the user, wherein the one or more other financial institutions sends the statement to the user electronically.

4. The system of claim 1, determining an account type and the one or more other financial institutions managing the second one or more financial accounts comprises recognizing a captured image of an article comprising financial accounts information associated with the second one or more financial accounts, wherein the captured image is captured via an image capture device, such as a camera, wherein financial account information includes one or more of an account number, routing number, or account identification number.

5. The system of claim 1, wherein communicating with the first financial institution and the one or more other financial institutions further comprises communicating with the first financial institution and the one or more other financial institutions to receive authorization to transact using the first one or more financial accounts and the second one or more financial accounts associated with the user.

6. The system of claim 1, wherein the processing device is further configured to allow for tracking between the first one or more financial accounts and the second one or more financial accounts associated with the user, such that the tracking allows for transferring of funds across the first one or more financial accounts and the second one or more financial accounts.

7. The system of claim 1, wherein the processing device is further configured to allow transacting with third party entities using the linked first one or more financial accounts and the second one or more financial accounts using a single application, wherein the transaction occurs independent of managing financial institution.

8. The system of claim 1, wherein providing viewable indication of the transaction and effects of the transaction on the first one or more financial accounts and the second one or more financial accounts via the single application further comprises displaying financial account information such as account balance associated with each of the first one or more financial accounts and the second one or more financial accounts on single viewable application.

9. The system of claim 1, wherein the processing device is further configured to allow for visual overlaid circles including a managing financial institution in one circle and a one or more financial accounts from the managing financial institution overlaid in a second or more circles.

10. The system of claim 1, wherein the processing device is further configured to notify the user of any changes in the linked first one or more financial accounts and the second one or more financial accounts, wherein changes include account balance changes or transactions occurring using the linked first one or more financial accounts or the second one or more financial accounts.

11. The system of claim 1, wherein the processing device is further configured to monitor the linked first one or more financial accounts and the second one or more financial accounts statement history for the user.

12. A computer program product for providing a link between one or more financial accounts, the computer program product comprising at least one non-transitory computer-readable medium having computer-readable program code portions embodied therein, the computer-readable program code portions comprising:
an executable portion configured for receiving an indication that a user accesses a first one or more financial accounts electronically, wherein accessing the first one or more financial accounts electronically includes accessing the first one or more financial accounts via online or mobile accessing capabilities, wherein the first one or more financial accounts are managed by a first financial institution;
an executable portion configured for receiving information of a second one or more financial accounts associated with the user, wherein the second one or more financial accounts are managed by one or more other financial institutions;
an executable portion configured for determining, based on received information, an account type and the one or more other financial institutions managing the second one or more financial accounts;
an executable portion configured for communicating with the first financial institution and the one or more other financial institutions;
an executable portion configured for linking the first one or more financial accounts with the second one or more financial accounts together into a single application;
an executable portion configured for allowing for transacting between the linked first one or more financial accounts and the second one or more financial accounts; and
an executable portion configured for providing viewable indication of the transaction and effects of the transaction on the first one or more financial accounts and the second one or more financial accounts via the single application.

13. The computer program product of claim 12, wherein determining an account type and the one or more other financial institutions managing the second one or more financial accounts further comprises one or more of:
an executable portion configured for recognizing user input of financial accounts information associated with the second one or more financial accounts, wherein financial account information includes one or more of an account number, routing number, or account identification number;
an executable portion configured for recognizing the second one or more financial accounts when a statement associated with the second one or more financial accounts is sent to the user, wherein the one or more other financial institutions sends the statement to the user electronically; or
an executable portion configured for recognizing a captured image of an article comprising financial accounts information associated with the second one or more financial accounts, wherein the captured image is captured via an image capture device, such as a camera, wherein financial account information includes one or more of an account number, routing number, or account identification number.

14. The computer program product of claim 12, wherein communicating with the first financial institution and the one or more other financial institutions further comprises communicating with the first financial institution and the one or more other financial institutions to receive authorization to transact using the first one or more financial accounts and the second one or more financial accounts associated with the user.

15. The computer program product of claim 12 further comprising an executable portion configured for allowing for tracking between the first one or more financial accounts and the second one or more financial accounts associated with the user, such that the tracking allows for transferring of funds across the first one or more financial accounts and the second one or more financial accounts.

16. The computer program product of claim 12 further comprising an executable portion configured for allowing transacting with third party entities using the linked first one or more financial accounts and the second one or more financial accounts using a single application, wherein the transaction occurs independent of managing financial institution.

17. The computer program product of claim 12 further comprising an executable portion configured for allowing for visual overlaid circles including a managing financial institution in one circle and a one or more financial accounts from the managing financial institution overlaid in a second or more circles.

18. The computer program product of claim 12 further comprising an executable portion configured for notifying the user of any changes in the linked first one or more financial accounts and the second one or more financial accounts, wherein changes include account balance changes or transactions occurring using the linked first one or more financial accounts or the second one or more financial accounts.

19. A computer-implemented method for providing a link between one or more financial accounts, the method comprising:
receiving an indication that a user accesses a first one or more financial accounts electronically, wherein accessing the first one or more financial accounts electronically includes accessing the first one or more financial accounts via online or mobile accessing capabilities, wherein the first one or more financial accounts are managed by a first financial institution;
receiving information of a second one or more financial accounts associated with the user, wherein the second one or more financial accounts are managed by one or more other financial institutions;
determining, based on received information, an account type and the one or more other financial institutions managing the second one or more financial accounts;
communicating with the first financial institution and the one or more other financial institutions;
linking, via a computer device processor, the first one or more financial accounts with the second one or more financial accounts together into a single application;
allowing for transacting between the linked first one or more financial accounts and the second one or more financial accounts; and
providing viewable indication of the transaction and effects of the transaction on the first one or more financial accounts and the second one or more financial accounts via the single application.

20. The method of claim 19, wherein determining an account type and the one or more other financial institutions managing the second one or more financial accounts further comprises one or more of:
recognizing user input of financial accounts information associated with the second one or more financial accounts, wherein financial account information includes one or more of an account number, routing number, or account identification number;
recognizing the second one or more financial accounts when a statement associated with the second one or more financial accounts is sent to the user, wherein the one or more other financial institutions sends the statement to the user electronically; or
recognizing a captured image of an article comprising financial accounts information associated with the second one or more financial accounts, wherein the captured image is captured via an image capture device, such as a camera, wherein financial account information includes one or more of an account number, routing number, or account identification number.

21. The method of claim 19, wherein communicating with the first financial institution and the one or more other financial institutions further comprises communicating with the first financial institution and the one or more other financial institutions to receive authorization to transact using the first one or more financial accounts and the second one or more financial accounts associated with the user.

22. The method of claim 19 further comprising allowing for tracking between the first one or more financial accounts and the second one or more financial accounts associated with the user, such that the tracking allows for transferring of funds across the first one or more financial accounts and the second one or more financial accounts.

23. The method of claim 19 further comprising allowing transacting with third party entities using the linked first one or more financial accounts and the second one or more financial accounts using a single application, wherein the transaction occurs independent of managing financial institution.

24. The method of claim 19 further comprising allowing for visual overlaid circles including a managing financial institution in one circle and a one or more financial accounts from the managing financial institution overlaid in a second or more circles.

25. The method of claim 19 further comprising notifying the user of any changes in the linked first one or more financial accounts and the second one or more financial accounts, wherein changes include account balance changes or transactions occurring using the linked first one or more financial accounts or the second one or more financial accounts.
